(19) United States
(12) Patent Application Publication
(10) Pub. No.: US 2012/0186775 A1
(43) Pub. Date: Jul. 26, 2012

(54) COOLING SYSTEM

(75) Inventor: Alexander George Fraser, Hants (GB)

(73) Assignee: PROTEAN ELECTRIC, Alton Road, Farnham, Surrey (UK)

(21) Appl. No.: 13/387,988

(22) PCT Filed: Jul. 8, 2010
(86) PCT No.: PCT/IB2010/053134

§ 371 Date: Mar. 9, 2012

(30) Foreign Application Priority Data
Jul. 29, 2009 (GB) 0913168.1

(51) Int. Cl. B60H 1/00

(52) U.S. Cl. 165/41

(57) ABSTRACT

A cooling system for a vehicle having an engine and an electric motor, wherein the electric motor is arranged to generate a motor torque for driving the vehicle, the cooling system comprising means for transferring heat energy between the motor cooling means and the engine cooling means upon the occurrence of a predetermined criteria, wherein the motor cooling means is for controlling the temperature of the electric motor and the engine cooling means is for controlling the temperature of the engine.

The present invention relates to a cooling system and in particular a cooling system for a vehicle having an engine and an electric motor, where the electric motor is arranged to generate a motor torque for driving the vehicle.

Hybrid vehicles use one or more electric motors to drive the vehicle with an internal combustion engine being used, directly or indirectly, as a power source for the one or more electric motors. For example, in a series hybrid the internal combustion engine is used, in combination with a generator, to convert the chemical energy in hydrocarbons fuel into electrical energy, which is stored in a convenient form.

Accordingly, the engine for a series hybrid vehicle typically only needs to be switched on when charge is required for powering the electric motors of the vehicle, otherwise a significant amount of fuel could be used by the engine unnecessarily. Consequently, depending on the type of journey, the engine of a series hybrid vehicle may be switched on and off a considerable number of times during a trip, where inevitably the engine will cool down when it is not running.

However, during the warm up phase of an internal combustion engine (i.e. the heating of an internal combustion engine from ambient temperature to an optimum engine temperature) the internal combustion engine will be operating less efficiently and in a manner that can cause damage to its internal components.

During this warm up phase a rich fuel mixture is used, which is poor for fuel efficiency and emissions. The excess fuel can ‘wash’ the engines cylinder bores of their lubricating oil film, thereby increasing the risk of wear.

Further, the partial combustion of fuel can result in hydrocarbon deposits forming on, for example, the engines piston crowns. These deposits can retain large amounts of heat, which can result in both a loss in peak volumetric efficiency of the engine and a greater risk of pre-ignition.

Additionally, as the lubricating oil of an engine is likely to be more viscous at ambient temperature compared to that at an optimum engine temperature, greater pumping and frictional losses can occur during warming up of an internal combustion engine.

When an engine is operating below its optimal temperature, the difference in thermal expansion coefficients of the various components results in clearances greater or less than their design require. For example, a steel crank main bearing journal operating inside an aluminium housing will have a tighter clearance at lower temperature, increasing the shear rate of the lubricating oil and hence the drag, whereas an aluminium piston in a steel bore will have increased clearance, with greater undesirable piston movement in the bore, which can cause wear and damage.

As the warm up period of an internal combustion engine can typically be anywhere between 2 to 15 minutes it is possible, due to the intermittent operation of an engine in a series hybrid vehicle, that an internal combustion engine for a series hybrid vehicle could be operating at a non-optimum temperature for a large percentage of the time it is running.

It is desirable to improve this situation.

In accordance with an aspect of the present invention there is provided a cooling system according to the accompanying claims.

This provides the advantage of allowing the temperature of an engine to be increased prior to the engine being run, thereby allowing the engine temperature to be closer to the engines optimum operating temperature at start up. This allows the engine to run more efficiently from start up and reduces the required warm up time.

The present invention will now be described, by way of example, with reference to the accompanying drawings, in which:

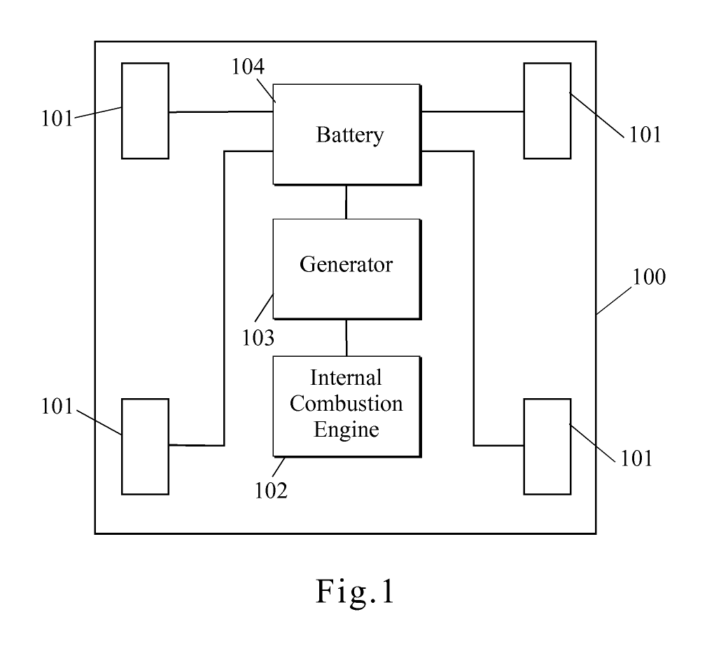

FIG. 1 illustrates a schematic of series hybrid vehicle;

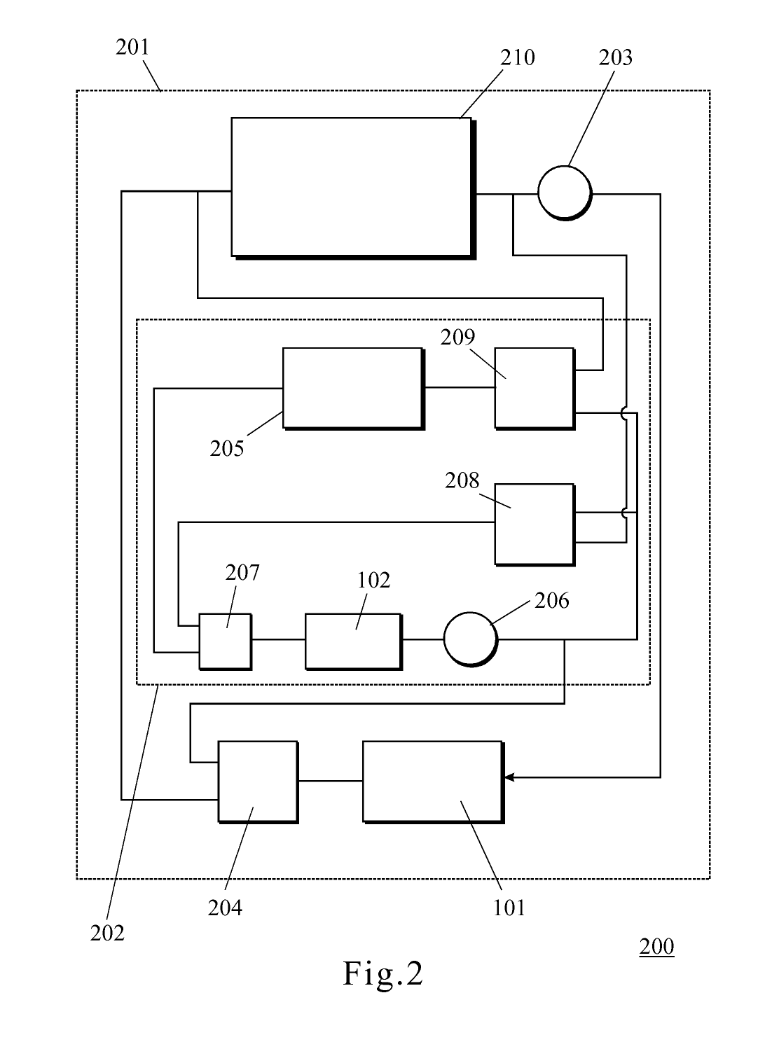

FIG. 2 illustrates a cooling system according to an embodiment of the present invention;

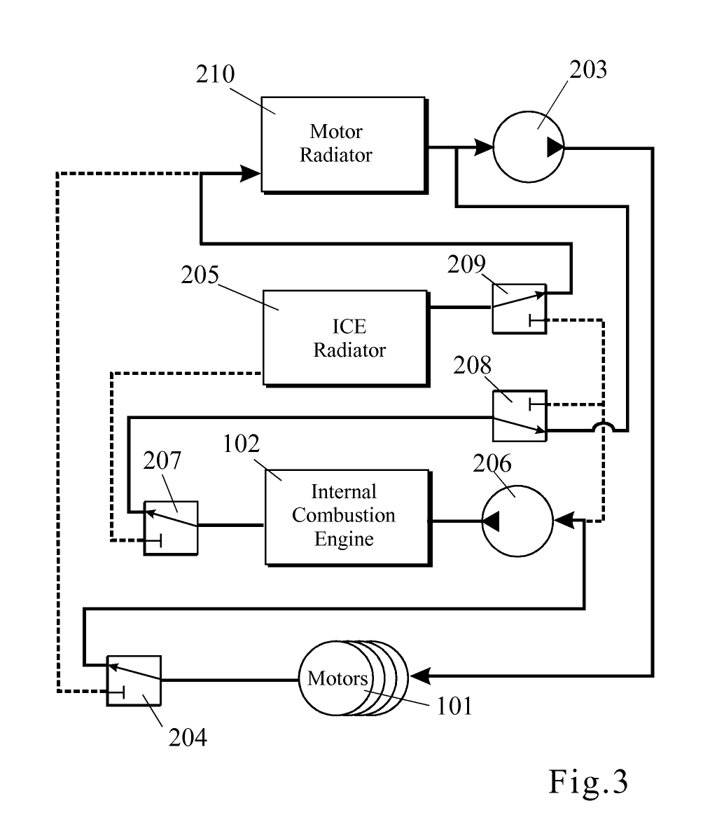

FIG. 3 illustrates a first configuration of the cooling system according to an embodiment of the present invention;

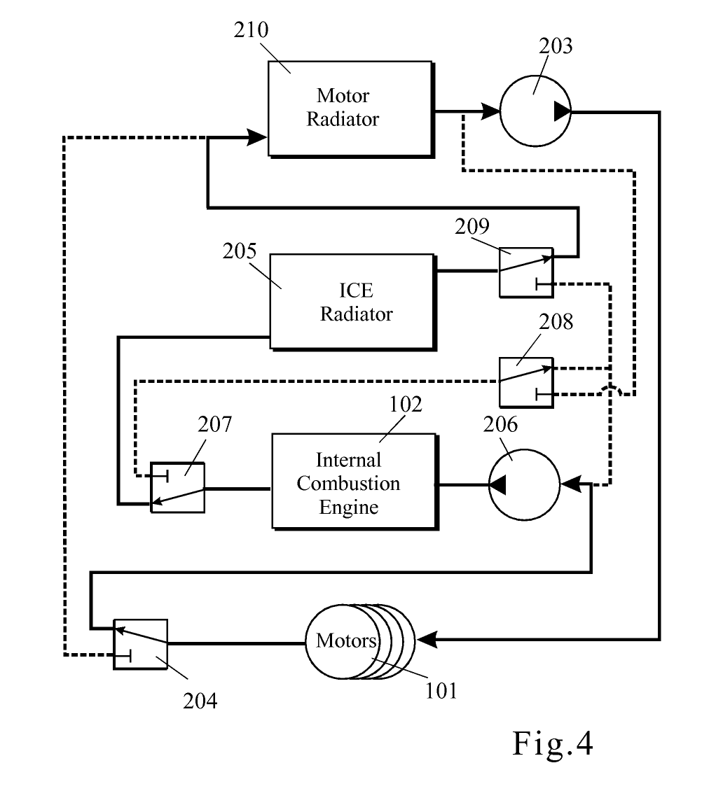

FIG. 4 illustrates a second configuration of the cooling system according to an embodiment of the present invention;

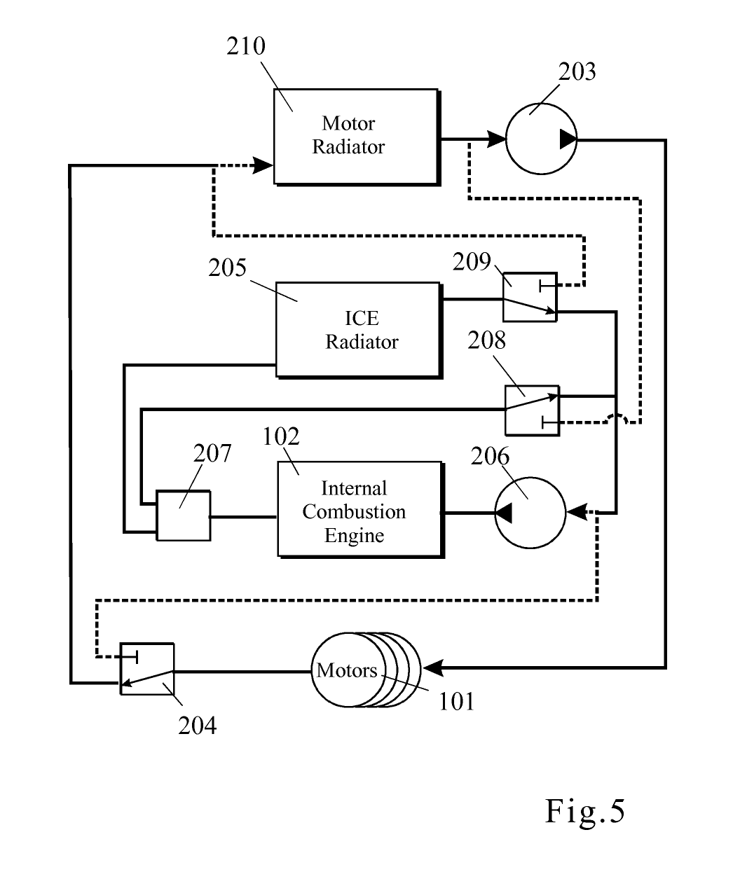

FIG. 5 illustrates a third configuration of the cooling system according to an embodiment of the present invention.

FIG. 1 illustrates a series hybrid vehicle 100 having a plurality of in-wheel electric motors 101, an internal combustion engine 102, a generator 103 and an energy storage device 104 such as a battery or capacitor.

The in-wheel electric motors 101 are arranged to provide torque for driving the vehicle 100, as is well known to a person skilled in the art. Typically an in-wheel electric motor 101 will be incorporated within at least two wheels (not shown) of the vehicle 100. For example, in a car having four wheels, in-wheel electric motors may be incorporated within all four of the wheels or within two of the wheels that are preferably located on the same axis.

An example of an in-wheel electric motor is described in patent application GB 2 440 251.

Although the present embodiment describes a series hybrid vehicle having in-wheel electric motors, as would be appreciated by a person skilled in the art, a series hybrid vehicle according to an embodiment of the present invention could use any form of electric motor arranged to generate torque for driving the vehicle, for example a single electric motor connected to a drive system that is arranged to transfer the drive torque generated by the electric motor to two or more of the wheels of the vehicle. Further, although the present embodiment describes the use of an internal combustion engine as the power source for the electric motor, where a generator is used to convert power generated by the engine into electric current that is used to directly run the electric motors or indirectly via the use of an energy storage device, the present invention is equally applicable to other power sources for the electric motors that require a cooling system, for example fuel cells.

The internal combustion engine 102 is coupled to the generator 103. When the engine 102 is running the engine 102 is arranged to drive the generator 103, which in turn generates charge that is stored in the energy storage device 104. The energy storage device 104 provides power to the in-wheel electric motors 101. The generator 103 could, however, be configured to bypass the energy storage device 104 to provide the required power directly to the in-wheel electric motors 101.

FIG. 2 illustrates a cooling system 200 for use in the series hybrid vehicle described above.

The cooling system 200 includes a motor cooling arrangement 201 and an engine cooling arrangement 202.

The motor cooling arrangement 201 includes a motor radiator 210, a first pump 203 and a first valve 204, where coolant is arranged to flow around the motor cooling arrangement 201 for providing cooling to the in-wheel electric motors 101, as is well known to a person skilled in the art. Typically the coolant will be a liquid. However, other fluids could be used. Alternatively, cooling could be provided using non-fluid materials, where cooling could be provided, for example, by conduction.

The in-wheel electric motors 101 have conduits within the electric motors to allow coolant to flow through the electric motors 101 to aid the removal of heat generated within the electric motors 101, for example within the electric motor coils, as is well known to a person skilled in the art.

The electric motor conduit outlets are coupled to the motor radiator inlet via the first valve 204, where the first valve 204 is arranged upon predetermined criteria, as described in detail below, to couple the motor cooling arrangement 201 to the engine cooling arrangement 202 to allow coolant to flow from the motor cooling arrangement 201 to the engine cooling arrangement 202.

The motor radiator outlet is coupled to the electric motor cooling conduit inlets via the first pump 203, where the first pump 203 is arranged to pump coolant around the motor cooling arrangement 201, thereby allowing coolant to flow through the electric motors 101 to cool the electric motors 101 with the motor radiator 210 being used to cool the coolant.

The engine cooling arrangement 202 includes an engine radiator 205, a second pump 206, a second valve 207, a third valve 208, and a fourth valve 209.

The engine 102 is designed to include conduits for allowing coolant to flow through the engine 102 to aid the removal of heat generated within the engine 102, as is well known to a person skilled in the art.

Typically, the same coolant will be used in the engine cooling arrangement 202 as for the motor cooling arrangement 201. As such, normally the coolant will be a liquid. However, other fluids could be used. Alternatively, cooling could be provided using non-fluid materials, where cooling could be provided, for example, by conduction.

The engine cooling conduit outlet is coupled to the second valve 207, which may be a thermostatically controlled valve.

Within an embodiment of the present invention, when the temperature of the coolant at the second valve 207 is below a predetermined temperature the second valve 207 is arranged to couple the engine cooling conduit outlet to the third valve 208. The third valve 208 is arranged, upon predetermined criteria described below, to couple the engine cooling arrangement 202 to the motor cooling arrangement 201 to allow coolant to flow from the engine cooling arrangement 202 to the motor cooling arrangement 201. If the third valve 208 is configured to not allow coolant to flow from the engine cooling arrangement 203 to the motor cooling arrangement 201 the third valve 208 allows the coolant to be redirected back to the engine 102 via the second pump 206.

When the temperature of the coolant at the second valve 207 is above a predetermined temperature the second valve 207 is arranged to couple the engine cooling conduit outlet to the engine radiator 205. When the second valve 207 is arranged to couple the engine cooling conduit outlet to the engine radiator 205 the second valve 207 can be configured to direct all the coolant through the radiator or just a certain percentage of the coolant with the rest of the coolant bypassing the radiator 205.

The engine radiator outlet is coupled to the fourth valve 209. The fourth valve 209 is arranged, upon predetermined criteria described below, to couple the engine cooling arrangement 202 to the motor cooling arrangement 201 to allow coolant to flow from the engine cooling arrangement 202 to the motor cooling arrangement 201. If the fourth valve 209 is configured to not allow coolant to flow from the engine cooling arrangement 202 to the motor cooling arrangement 201 the fourth valve 209 allows the coolant to be redirected back to the engine 102 via the second pump 206.

The operation of the first valve 204, third valve 208 and fourth valve 209 will typically be controlled by a central controller. However, as would be appreciated by a person skilled in the art, the operation of the valves could be operated by any means. For example, by using a stepper motor that receives a position signal from a central controller.

Additionally, the operation of the second valve 207 may also be controlled via a controller. As such, if the second valve 207 is a thermostatic valve the controller can be arranged to override the thermal settings of the valve. Alternatively, if the second valve 207 is not a thermostatic valve the operation of the valve will typically be controlled solely by a controller.

In accordance with embodiments of the present invention, based on the predetermined conditions under which the first valve 204, second valve 207, third valve 208 and fourth valve 209 operate the cooling system can be placed in different modes of operation.

For example, dependent upon the difference in temperature of the coolant passing through the engine 102 and the electric motors 101 and/or an operating condition of the engine 102 and/or the electric motors 101 the first valve 204, third valve 208 and fourth valve 209 can be configured to either isolate the coolant flow through the engine cooling arrangement 202 and the motor cooling arrangement 201 or couple the engine cooling arrangement 202 and the motor cooling arrangement 201 to allow coolant to flow from the motor cooling arrangement 201 to the engine cooling arrangement 202 and vice versa.

FIGS. 3 and 4 illustrate a mode of operation of the cooling system 200 in which the motor cooling arrangement 201 is coupled to the engine cooling arrangement 202 to allow coolant to flow from the motor cooling arrangement 201 to the engine cooling arrangement 202 and vice versa. That is to say, the first valve 204 is configured to allow coolant to flow from the motor cooling arrangement 201 to the engine cooling arrangement and the third valve 208 and the fourth valve 209 are configured to allow coolant to flow from the engine cooling arrangement 202 to the motor cooling arrangement 201.

FIG. 5 illustrates a mode of operation of the cooling system 200 in which the motor cooling arrangement 201 is decoupled from the engine cooling arrangement 202, thereby preventing the flow of coolant from the motor cooling arrangement 201 to the engine cooling arrangement 202.

The features in FIGS. 3, 4 and 5 that correspond to the features in FIG. 2 have been given the same reference numerals as those given in FIG. 2.

Examples of criteria for placing the cooling system 200 into the different modes of operation will now be described.

If a controller determines that the engine temperature is less than one or more of the electric motors 101 or the coolant in the motor cooling arrangement 201 the controller is arranged to configure the first valve 204, the third valve 208 and/or fourth valve 209 of the cooling system 200 to allow coolant to flow between the motor cooling arrangement 201 and the engine cooling arrangement 202, as shown in FIGS. 3 and 4. Typically the determination that the engine temperature is less than the one or more electric motors 101 will be performed when the engine 102 is not running.

The temperature of the engine 102 and electric motors 101 can be determined by any suitable means; for example, by measuring the temperature of components within the engine 102 and electric motors 101 respectively or by measuring the temperature of coolant that has passed through the engine and electric motors respectively.

To change the thermal capability of the system the second valve 207 is arranged to direct the engine cooling arrangement coolant so that it bypasses the engine radiator 205 if the coolant temperature is below a predetermined temperature (as shown in FIG. 3) and to direct the engine cooling arrangement coolant through the engine radiator 205 if the coolant temperature is above a predetermined value (as shown in FIG. 4).

Where a determination has been made that the engine temperature is less than the temperature of one or more of the electric motors 101 and the first valve 204, the third valve 208 and/or the fourth valve 209 have been configured to allow coolant to flow between the motor cooling arrangement 201 and the engine cooling arrangement 202, for a system that is not able to distinguish between engine temperature and electric motor temperature once the motor cooling arrangement 201 and engine cooling arrangement 202 have been coupled it would be preferable that the first valve 204, the third valve 208 and/or fourth valve 209 be configured to prevent coolant flowing between the motor cooling arrangement 201 and engine cooling arrangement 202 once a determination has been made that the engine 102 has been switched on and is running. That is to say, once the engine 102 is running the first valve 204, the third valve 208 and/or the fourth valve 209 are controlled to decouple the motor cooling arrangement 201 from the engine cooling arrangement 202.

By diverting the motor cooling arrangement coolant into the engine cooling arrangement 202 this has the advantage of allowing the temperature of the engine 102 to be increased before it is switched on. Accordingly, the engine 102 will be closer to its optimum operating temperature when the engine 102 is switched on. Consequently, in such a configuration, it may not be necessary to use a rich fuel mixture when starting the engine 102, thereby increasing fuel efficiency and minimising wear upon the engine.

With the motor cooling arrangement 201 and the engine cooling arrangement 202 decoupled to prevent coolant flowing between the motor cooling arrangement 201 and the engine cooling arrangement 202 (as shown in FIG. 5), the second valve 207 is arranged to direct the engine cooling arrangement coolant so that it bypasses the engine radiator 205 if the coolant temperature is below a predetermined temperature and to direct the engine cooling arrangement coolant through the engine radiator 205 if the coolant temperature is above a predetermined value.

However, in the situation where the electric motors 101 are running and the engine 102 is not running with the first valve 204 being arranged to couple the motor cooling arrangement 201 and the engine cooling arrangement 202, a controller can be utilised to control the operation of the second valve 207 to allow the coolant to pass through the engine radiator 205 independent of the coolant temperature, thereby allowing enhanced cooling to be applied to the coolant and increase electric motor performance. If, however, a determination is made that the engine 102 is shortly to be switched on the second valve 207 is configured to bypass the engine radiator 205 and the motor radiator 202 thereby allowing engine temperature to be increased further before engine switch on.

To enhance engine cooling once the electric motors 101 have stopped, and hence the vehicle has stopped, preferably the controller is arrange to operate the first valve 204 to couple the engine cooling arrangement 202 and the motor cooling arrangement 201 to increase cooling of the engine.

It should be noted that when the heat rejection from a running engine is unsustainable, under certain circumstance where the load on the electric motors is low (e.g. when the electric motors are operating at a low speed) the engine cooling arrangement 202 and motor cooling arrangement 201 can be coupled, thereby allowing the engine to benefit from the cooling capacity of the motor radiator and the considerable thermal capacitance of the electric motors and the motor cooling arrangement.

Where engine and electric motor temperature information is available, for example via temperature probes on the engine and electric motors, examples of different cooling system configurations are listed below in table 1.

TABLE 1

| | | Engine temp | Engine temp |
|---|---|---|---|
| Engine | Motor | less than | greater than |
| condition | condition | motor temp | motor temp |
| Engine off | Fast | Mode 1 | Mode 3 |
| Engine off | Slow/stationary | Mode 1 | Mode 3 |
| | ‘on’ | | |
| Engine off | Stationary | Mode 1 | Mode 3 |
| | ‘off’ | | |
| Engine use | Fast | Mode 2 | Mode 3 |
| imminent | | | |
| Engine use | Slow/stationary | Mode 2 | Mode 3 |
| imminent | ‘on’ | | |
| Engine use | Stationary | N/A | N/A |
| imminent | ‘off’ | | |
| Engine on | Fast | Mode 3 | Mode 3 |
| Engine on | Slow/stationary | Mode 2 or 3 | Mode 3 |
| | ‘on’ | | |
| Engine on | Stationary | Mode 2 | Mode 3 |
| | ‘off’ | | |

Mode 1 corresponds to the cooling system illustrated in FIG. 3, where valve 1 204 is arranged to couple the motor cooling arrangement 201 to the engine cooling arrangement 202 to allow coolant to flow from the motor cooling arrangement 201 to the engine cooling arrangement 202 and valve 2 is arranged to direct coolant to the motor radiator 210 via the engine radiator 205.

Mode 2 corresponds to the cooling system illustrated in FIG. 4, where valve 1 204 is arranged to couple the motor cooling arrangement 201 to the engine cooling arrangement 202 to allow coolant to flow from the motor cooling arrangement 201 to the engine cooling arrangement 202 and valve 2 is arranged to direct coolant to bypass the motor radiator 202 and the engine radiator 205.

Mode 3 corresponds to the cooling system illustrated in FIG. 5, where valve 1 204 is arranged to decouple the motor cooling arrangement 201 and the engine cooling arrangement 202.

However, as would be appreciated by a person skilled in the art, different cooling system 200 configurations could be adopted to those described above.

Although the present embodiment allows heat transfer to occur between the motor cooling arrangement 201 and engine cooling arrangement 202 by allowing coolant to flow between the motor cooling arrangement 201 and the engine cooling arrangement 202, other forms of heat transfer could be used. For example, a heat exchanger could be coupled between the motor cooling arrangement 201 and the engine cooling arrangement 202 that is arranged to allow the motor cooling arrangement 201 and the engine cooling arrangement 202 to be thermally coupled based on the same criteria as that described above with respect to the operation of the first valve, third valve and fourth valve.

Additionally, the motor cooling arrangement 201 can be configured to also provide cooling to the generator 103 in a similar manner as for the electric motors 101.

It will be apparent to those skilled in the art that the disclosed subject matter may be modified in numerous ways and may assume embodiments other than the preferred forms specifically set out as described above, for example the cooling system could be utilised in an any form of vehicle having an electric motor for generating torque for driving the vehicle and an engine, for example a parallel hybrid vehicle where both the engine and the electric motor can be used to generate torque for driving the vehicle.

1. A cooling system for a vehicle having an electric motor, wherein the electric motor is arranged to generate a motor torque for driving the vehicle, and a power source for the electric motor, the cooling system comprising means for transferring heat energy between first cooling means and second cooling means upon the occurrence of a predetermined criteria, wherein the first cooling means is for controlling the temperature of the electric motor and the second cooling means is for controlling the temperature of the power source for the electric motor, wherein the power source is an internal combustion engine and the means for transferring heat energy is arranged to inhibit the transfer of heat energy between the first cooling means and the second cooling means upon the internal combustion engine being switched on.

2. A cooling system according to claim 1, wherein the internal combustion engine is coupled to a generator that is arranged to convert power generated by the engine into an electric current.

3. A cooling system according to claim 2, wherein the generator is coupled to an energy storage device that is arranged to store electrical charge generated by the generator and wherein the energy storage device is arranged to provide a current to the electric motor.

4. A cooling system according to claim 1, wherein the predetermined criteria upon which the means for transferring transfers heat energy between the first cooling means and the second cooling means is dependent upon the temperature difference between the first cooling means and the second cooling means.

5. A cooling system according to claim 1, wherein the predetermined criteria upon which the means for transferring transfers heat energy between the first cooling means and the second cooling means is dependent upon the temperature difference between the first cooling means and the second cooling means and/or an operating condition of the power source and/or the electric motor.

6. A cooling system according to claim 1, wherein the predetermined criteria upon which the means for transferring transfers heat energy between the first cooling means and the second cooling means is dependent upon the determination that the motor is providing torque, the power source is switched off and the temperature of the first cooling means is higher than the second cooling means.

7. A cooling system according to claim 1, wherein the predetermined criteria upon which the means for transferring transfers heat energy between the first cooling means and the second cooling means is dependent upon the determination that the motor is switched off and the power source is switched off.

8. A cooling system according to claim 1, wherein the predetermined criteria upon which the means for transferring transfers heat energy between the first cooling means and the second cooling means is dependent upon the determination that the temperature of the first cooling means is at a higher temperature than the temperature of the second cooling means.

9. A cooling system according to claim 1, wherein the second cooling means is arranged to supply coolant to the power source.

10. A cooling system according to claim 1, wherein the first cooling means is arranged to supply coolant to the electric motor.

11. A cooling system according to claim 1, wherein the means for transferring is a heat exchanger.

12. A cooling system according to claim 1, wherein the means for transferring is a valve arranged to allow coolant supplied to the electric motor to enter the second cooling means for supply to the power source upon the determination that coolant supplied to the electric motor is at a higher temperature than the coolant supplied to the power source.

13. A cooling system according to claim 1, wherein the cooling system is arranged to operate in a vehicle having a generator for generating an electric current from the power generated by the engine, wherein the first cooling means is arranged to control the temperature of the generator.

14. A cooling system according to claim 1, wherein the power source is arranged not to be switched on until the second cooling means has raised the power source temperature to a predetermined temperature.

15. A cooling system according to claim 1, wherein the cooling system is arranged to operate in a vehicle wherein the electric motor is a plurality of in wheel electric motors.

16. A cooling system according to claim 1, wherein the means for transferring heat energy is arranged to inhibit the transfer of heat energy from the second cooling means to the first cooling means upon a determination that the second cooling means is at a higher temperature than the first cooling means.

17. A cooling system according to claim 16, wherein the means for transferring heat energy is arranged to inhibit the transfer of heat energy by preventing the supply of coolant from the electric motor to the second cooling means.

18. A vehicle comprising a cooling system having an electric motor, wherein the electric motor is arranged to generate a motor torque for driving the vehicle, and a power source for the electric motor, the cooling system comprising means for transferring heat energy between first cooling means and second cooling means upon the occurrence of a predetermined criteria, wherein the first cooling means is for controlling the temperature of the electric motor and the second cooling means is for controlling the temperature of the power source for the electric motor, wherein the power source is an internal combustion engine and the means for transferring heat energy is arranged to inhibit the transfer of heat energy between the first cooling means and the second cooling means upon the internal combustion engine being switched on.

19. A vehicle according to claim 18, wherein the internal combustion engine is coupled to a generator that is arranged to convert power generated by the engine into an electric current, wherein the generator is coupled to an energy storage device that is arranged to store electrical charge generated by the generator and wherein the energy storage device is arranged to provide a current to the electric motor, wherein the engine is arranged to be switched on to allow the generation of electric charge upon a predetermined criteria being met.

20. A vehicle according to claim 18, wherein the first cooling means and/or the second cooling means include coolant that is arranged to be diverted through a radiator dependent upon a predetermined criteria.
